(19) United States
(12) Patent Application Publication
(10) Pub. No.: US 2006/0161487 A1
(43) Pub. Date: Jul. 20, 2006

(54) Method for establishing lines of credit

(75) Inventors: Puneet Saxena, Prospect Heights, IL (US); Tushar M. Waghmare, Bangalore (IN); James F. Connaughton, Bannockburn, IL (US)

Correspondence Address: MICHAEL BEST & FRIEDRICH LLP, Two Prudential Plaza, 180 North Stetson Avenue, Suite 2000, CHICAGO, IL, 60601, US

(73) Assignee: HSBC North America Holdings Inc., Prospect Heights, IL (US)

(21) Appl. No.: 11/112,223

(22) Filed: Apr. 22, 2005

Related U.S. Application Data
(60) Provisional application No. 60/644,862, filed on Jan. 18, 2005.

(51) Int. Cl. G06Q 40/00

(52) U.S. Cl. 705/35

(57) ABSTRACT

A method of assigning a credit limits to individual credit applicants. The method utilizes an algorithm to determine the profitability of a credit account and applies the algorithm to a plurality of credit accounts using a chi squared method to group the accounts into segments. An optimization process is performed on each segment to determine a credit limit that yields the maximum profitability of accounts in that segment. Credit applicants are then given the credit limit corresponding to the segment into which they fall. A shadow policy is used to selectively increase a credit applicant's credit limit.

### BACKGROUND

The present invention relates to a method for assigning credit limits to applicants seeking lines of credit. Particularly, the present invention relates to a strategy for assigning credit limits to credit card applicants.

Conventional credit limit strategies typically group applicants together using their respective credit histories. Those applicants with similar credit histories, good or bad, are typically grouped together. As a preliminary matter, a typical credit limit strategy might analyze historical credit data to determine what characteristics of a credit applicant tend to indicate whether that applicant will be a good or bad credit risk. Once those relevant characteristics are identified, applicants are grouped, each group having a different combination of the analyzed characteristics. For example, characteristics that are typically examined are income, number of credit inquires, FICO score, etc. When an individual applies for a credit card, his or her individual characteristics are examined and compared to the characteristics of the various groups that are already created based upon the predetermined credit limit strategy. The individual applicant is then grouped with those accounts having the same characteristics and is given the credit limit that is established for the particular group in which he or she fits.

### SUMMARY

The present invention relates to a method of assigning a credit limit to an individual credit applicant. The method comprises creating an algorithm that determines the profitability of a credit account. The algorithm has a plurality of variables that represent credit data. The method also comprises applying the algorithm to a plurality of existing credit accounts using a chi squared method to group the existing accounts into segments. An optimization policy is applied to each segment to establish a credit limit for each segment that maximizes the profitability of the accounts in that segment. The credit data for the individual credit applicant is analyzed to place the individual credit applicant in one of the segments. The individual credit applicant is assigned the credit limit of the segment into which the individual credit applicant was placed, and a shadow policy is applied to the individual credit applicant to selectively increase the individual credit applicant's credit limit.

Other aspects of the invention will become apparent by consideration of the detailed description and accompanying drawings.

### BRIEF DESCRIPTION OF THE DRAWINGS

FIG. 1 is a flowchart illustrating a method according to one embodiment of the present invention for segmenting credit accounts into segments according to a profitability algorithm.

FIG. 2 is a flowchart illustrating a method according to one embodiment of the present invention for assigning a credit limit to a credit applicant.

FIG. 3 illustrates a sample matrix for an example segment of FIG. 1 according to one embodiment of the present invention.

FIG. 4 illustrates a chart illustrating one embodiment of a shadow policy according to present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

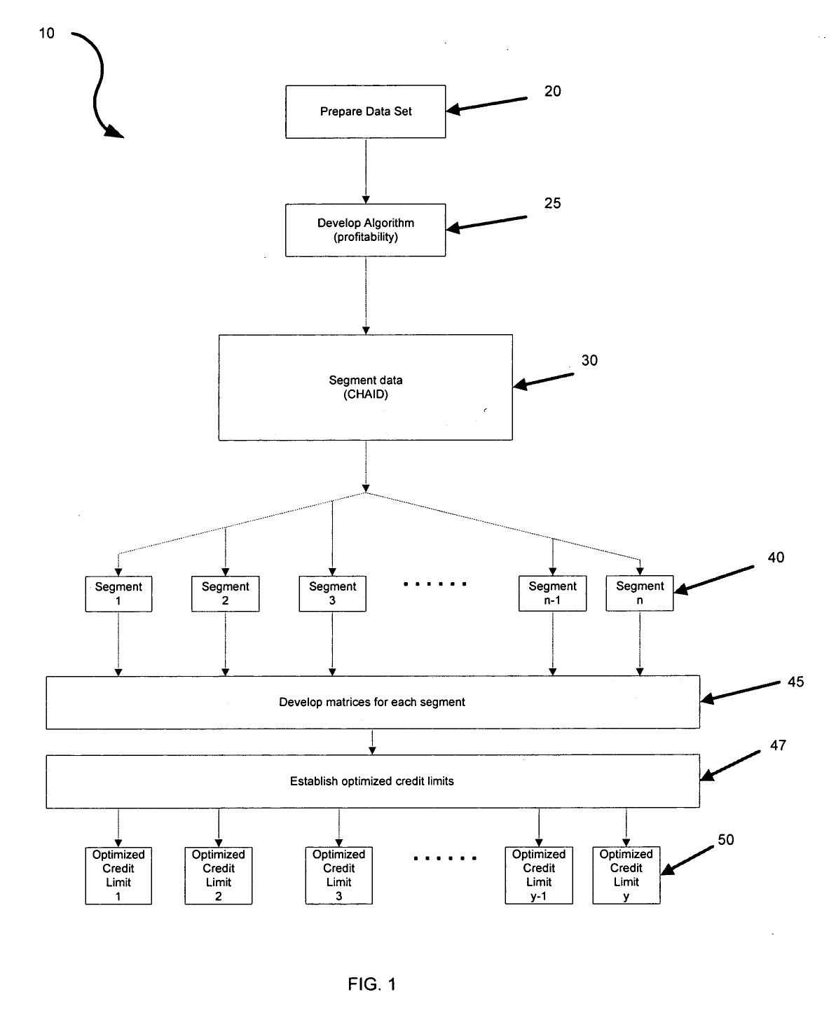

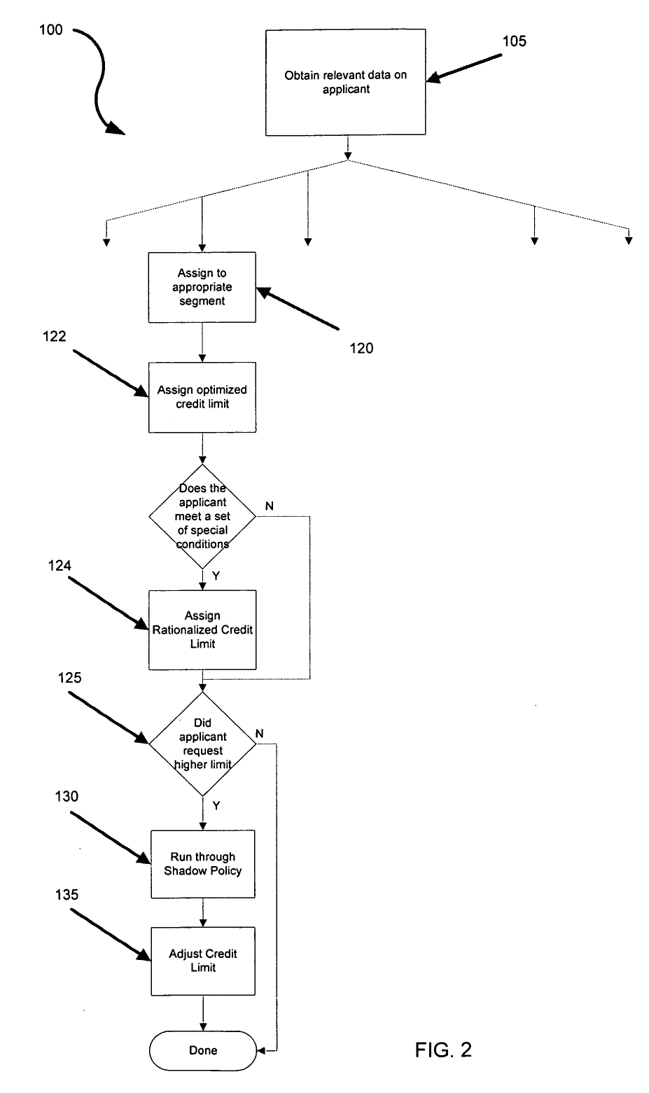

As shown generally in the flow chart of FIGS. 1 and 2, the present invention provides a method for assigning credit limits to credit applicants. In the embodiment of the invention as shown in FIGS. 1 and 2, the method is divided into two general processes 10 and 100. The first process 10 is the method by which a creditor or a merchant that is a customer of the creditor establishes credit limits for various groups of credit applicants. The credit limit groups may be established for a merchant by the merchant itself or by a creditor who administers credit card programs for its merchants.

Referring to FIG. 1, in either case, the first step in the method of establishing credit limits is to prepare a data set at step 20. The data set is composed of information pertaining to the credit card holders (i.e., credit applicants) of the merchant. For example, the data set may include information on average balances, types of sales, credit losses, etc., for each customer having a credit card with the particular merchant. At step 20, when the data has been gathered, it must be prepared by first eliminating outlier data. Outlier data is eliminated using any of several conventional standard-of-deviation methods.

When outliers have been eliminated from the data set, the data set is segmented at step 30 into groups of accounts 40. The accounts are analyzed based on common characteristics among various credit card customers of the merchant to establish groups or segments 40 of substantially homogeneous accounts. To create these segments, an algorithm is first developed in step 25 that reflects the merchant's profitability from an individual credit card account. The algorithm approximates the profitability of an account using various variables that represent credit applicant data. According to the illustrated embodiment of the present invention, the algorithm used to calculate the profitability of an account is:
Profitability=Income−Cost of Funds−Loss
where Income is calculated by adding Discount Income, Finance Charges paid, Over Limit Fees paid, Late Fees paid, NSF Fees paid, and a percentage of Insurance Premiums paid. Cost of Funds is calculated as a percentage of Average Balance and Loss is calculated as one of Charged Off Principal Amount, Charged Off Interest Amount, Charged Off Total Fees, or Potential Charge Off calculated as a percentage of Average Balance. All of these variables are amounts that will be readily known to one of ordinary skill in the art and may be calculated in different ways by different creditors. Regardless of how the individual variables are calculated or exactly what variables are used, the algorithm used to segment accounts will be one that calculates the Profitability of an account.

After the algorithm is developed at step 25, a chi-square analysis called CHAID (Chi-square Automatic Interaction Detection) is applied to the data set at step 30 based on the algorithm to establish various segments 40 within the data set. As will be readily apparent to those of skill in the art, CHAID is an exploratory method used to study the relationship between a dependent variable and a series of predictor variables. Conventional software such as Angoss Software Corporation's KnowledgeSTUDIO® software can be used to segment the data set according to the developed algorithm.

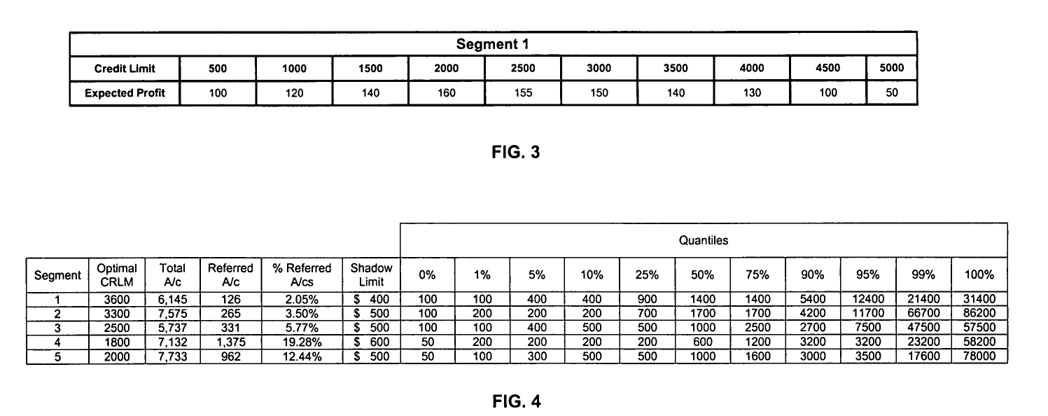

Once the segments have been created, matrices are developed in step 45 by calculating the profits that would be expected to be generated for each segment, assuming a particular credit line is given to individuals within that segment. In other words, for a particular segment, a matrix is generated indicating the profit expected for the accounts in that segment given a particular credit limit. For example, a matrix might be developed that indicates the profits that would be expected if accounts in that segment were given a credit limit of $2000, $2500, or $3000. For another segment, the profits expected given a credit limit of $2000, $2500 or $3000 might be different, thus resulting in the various matrices for the segments. If there is no data relating to the profitability of a particular segment of accounts based on a particular assigned credit limit, a profitability is calculated for that segment by interpolating between two existing credit limits. A sample matrix for an example segment is shown in FIG. 3.

FIG. 3 illustrates a sample matrix for an example segment numbered “1”. The matrix shows a calculated expected profitability for those accounts in segment 1 given an assigned credit limit of $500, $1000, $1500 . . . $4500. As can be seen in FIG. 3, assigning a credit limit of $2000 to those accounts in segment 1 yields the highest expected profitability—$160.

The matrices developed in step 45 are then run through an optimization model at step 47 to determine the optimal credit limit to be assigned to each segment 40 to generate maximum profits for the creditor or merchant, subject to certain business constraints. In addition to maximizing profits, the optimization model attempts to realize certain business constraints such as increased sales, increased customer satisfaction, and maintained losses within desired levels. For example, again referring to FIG. 3, although the matrix generated for example segment 1 indicates that profitability for that segment can be maximized by assigning to accounts in that segment a credit limit of $2000, the optimization model may determine that a different credit limit (e.g., $1500 or $2500) better meets the goals of increasing sales, increasing customer satisfaction, and maintaining losses with desired levels, while still maintaining a high profitability. For example, the profitability expected of accounts in example segment 1 only decreases by $5 ($160−$155) when the assigned credit limit is increased from $2000 to $2500. In the optimization model, it may be determined that sales and customer satisfaction are increased to such a degree in segment 1 when the assigned credit limit is $2500 instead of $2000 that it is worth sacrificing $5 of profitability to achieve the sales and satisfaction increases. The credit limit to be assigned to a segment of accounts may be increased, decreased, or maintained at the credit limit that indicates the maximum profitability according to the matrix developed for the segment in step 45. In this way, optimized credit limits are assigned to each of the segments 40 through the optimization model at step 47.

When a new credit applicant requests a credit card from the creditor or merchant (and after he or she has been approved or denied according to any of a number of known approval/denial strategies not discussed herein) a process 100, as shown in FIG. 2, is used to assign the new credit applicant a credit limit. To assign the new applicant a credit limit, an analysis of the variables that are fed into the CHAID process is made. Personal information that correlates to the variables that are used to create the segments in steps 25 and 30 of FIG. 1 is obtained for the particular credit applicant at step 105 from any of the various credit bureaus, such as Equifax, Experian, Transunion, etc. With this personal information for the particular credit applicant obtained, the credit applicant is placed into one of the created segments at step 120. With the credit applicant placed in a particular segment, he or she is then simply assigned at step 122 the credit limit established for that segment during the optimization process of step 47 of FIG. 1.

After the new credit applicant has been assigned a credit limit based upon an examination of which group (segment) he or she falls into, the new credit applicant's assigned credit limit may be adjusted in step 124. A small minority of applicants may meet a set of special conditions that will cause their assigned credit limits to be adjusted. If certain business rules are met for a new applicant, regardless of which segment he or she falls into, his or her assigned credit limit may be adjusted. For example, if a new credit applicant's file is less than 36 months old or if the number of trades for the new applicant is less than or equal to 2, or if other special circumstances exist, it may be desired to adjust the new applicant's credit limit in step 124, regardless of which segment he or she falls into. If a rationalization policy is desired, the rationalized credit limit is assigned in step 124 to a small minority of new applicants who meet a particular set of special circumstances, regardless of the optimized credit limit assigned to them in step 120 according to the segment in which they are placed. If a rationalization policy is not used, the optimized credit limit assigned in step 122 is fed directly into a shadow policy (discussed below) at step 125.

After the individual credit applicant has been assigned the optimized credit limit based upon an examination of which group (segment) he or she falls into (or, if used, after determining whether he or she meets the set of special circumstances causing him or her to be assigned the rationalized credit limit discussed above), a determination of whether to give that particular credit applicant more credit is made in a shadow policy. The shadow policy is a policy that is applied to the individual credit applicant only if the credit applicant has requested a greater credit limit than he or she is assigned at step 122 according to the segment he or she falls into (or step 124 if he or she met the special set of conditions).

At the time the credit applicant applies for a credit card, he or she is asked to indicate his or her desired credit limit. If the credit applicant has requested an amount that is greater than the amount he or she is given according to the segment into which he or she falls (or the rationalized credit limit), the shadow policy is applied to that credit applicant. For each segment, a pre-established shadow policy increase is determined. The pre-established shadow policy increase is subjectively determined for each segment by analyzing customer satisfaction within each particular segment. Based on the level of satisfaction with various assigned credit limits within a segment, a pre-established increase is determined that is to be applied to applicants that fall into that segment but who request a greater credit limit than they are assigned in step 122 (optimized credit limit) or 124 (rationalized credit limit).

If the individual credit applicant has requested a higher credit limit than he or she is assigned, that credit applicant's credit limit is increased by the pre-established shadow policy increase amount beyond the credit limit assigned in steps 122 and 124 and up to the credit limit requested by the applicant. A chart showing one embodiment of a shadow policy according to present invention is shown in FIG. 4. In FIG. 4, for example, referring to the information for segment 5, it can be seen that 25% of the accounts are satisfied if they are given $500 more than the established optimized credit limit of $2000. Referring also to the information provided for segment 5 accounts, 50% of the accounts are satisfied if they are given $1000 more than the segment 5 optimized credit limit of $2000. Either amount, $500 or $1000, or any other amount including those shown for the other quantiles listed in FIG. 4, could have been chosen for the pre-established shadow policy amount. However, according to the shadow policy embodiment shown in FIG. 4, a subjective determination was made to choose $500 as the pre-established shadow policy increase amount to be applied in step 135 of FIG. 2.

Various features and advantages of the invention are set forth in the following claims.

1. A method of assigning a credit limit to a credit applicant, the method comprising:
creating an algorithm that determines the profitability of a credit account, the algorithm having a plurality of variables that represent credit data;
applying the algorithm to a plurality of existing credit accounts using a chi squared method to group the existing accounts into segments;
applying an optimization policy to each segment to establish an optimized credit limit for each segment;
collecting the credit data for the credit applicant and comparing the collected credit data to the credit data of the segmented existing accounts to place the credit applicant in one of the segments;
assigning to the credit applicant the optimized credit limit of the segment into which the credit applicant was placed; and
applying a shadow policy to the credit applicant to determine whether to change the credit applicant's assigned credit limit.

2. The method of claim 1, wherein the profitability is calculated by subtracting a cost of funds amount and a loss amount from an income amount.

3. The method of claim 1, wherein the chi squared method is a chi-square automatic interaction detection method.

4. The method of claim 1, further comprising the step of assigning to the credit applicant a rationalized credit limit different than the optimized credit limit if the applicant satisfies a set of business rules.

5. The method of claim 4, wherein the set of business rules includes at least one of a credit applicant's file being less than 36 months old and a number of trades for the individual credit applicant being less than or equal to 2.

6. The method of claim 1, wherein applying the shadow policy comprises receiving a desired credit limit from the credit applicant, establishing a maximum increase over the optimized credit limit for the segment into which the credit applicant is placed, and selectively increasing the credit applicant's credit limit beyond the optimized credit limit if the desired credit limit is greater than the optimized credit limit.

7. The method of claim 6, wherein the selectively increasing step comprises increasing the credit applicant's credit limit by an amount equal to or less than the maximum increase.

8. A method of assigning a credit limit to a credit applicant, the method comprising:
creating segments of credit applicants, each segment having credit applicants that exhibit similar profitability characteristics;
obtaining data relevant to assigning a credit limit for the credit applicant;
assigning the credit applicant to one of the segments based upon at least some of the obtained data; and
assigning to the credit applicant an optimized credit limit associated with the segment to which the credit applicant was assigned.

9. The method of claim 8, further comprising:
receiving a desired credit limit from the credit applicant; and
comparing the desired credit limit with the optimized credit limit and if the desired credit limit is greater than the optimized credit limit, selectively assigning to the credit applicant a new credit limit less than or equal to the desired credit limit instead of the optimized credit limit.

10. The method of claim 8, further comprising:
determining whether at least some of the data obtained for a credit applicant meets a set of business rules and, if the data meets that set of business rules, assigning to the credit applicant a rationalized credit limit different than the optimized credit limit, regardless of the segment to which the credit applicant was assigned.

11. A method of assigning a credit limit to a credit applicant, the method comprising:
developing a profitability algorithm to calculate the profitability of a credit account;
obtaining a set of data on a plurality of credit accounts;
segmenting the data into a plurality of account segments by applying the profitability algorithm to the set of data on a plurality of credit accounts;
developing for each of the plurality of account segments a matrix of expected profitabilities of accounts within that account segment for at least two possible credit limits to be assigned to each account;
using an optimization model to choose from each matrix one of the possible credit limits to be an optimized credit limit, profitability being one factor considered by the optimization model;
obtaining data relevant to assigning a credit limit to the credit applicant;
assigning the credit applicant to one of the plurality of account segments based on the data obtained relevant to assigning a credit limit for the credit applicant; and
assigning to the credit applicant the optimized credit limit associated with the segment to which the credit applicant was assigned.

12. The method of claim 11, wherein the wherein the data is segmented using a chi squared method.

13. The method of claim 12, wherein the chi squared method is a chi-square automatic interaction detection method.

14. The method of claim 11, wherein the optimization model further considers at least one of increased sales, increased customer satisfaction, and losses within acceptable levels.

15. The method of claim 11, further comprising:
receiving a desired credit limit from the credit applicant; and
comparing the desired credit limit with the optimized credit limit and if the desired credit limit is greater than the optimized credit limit, selectively assigning to the credit applicant a new credit limit less than or equal to the desired credit limit instead of the optimized credit limit.

16. The method of claim 11, further comprising:
determining whether the data obtained relevant to assigning a credit limit to the credit applicant meets a set of business rules and, if the data meets that set of business rules, assigning to the credit applicant a rationalized credit limit different than the optimized credit limit, regardless of the segment to which the credit applicant was assigned.
